(19) United States
(12) Patent Application Publication
(10) Pub. No.: US 2006/0045899 A1
(43) Pub. Date: Mar. 2, 2006

(54) Antimicrobial composition for medical articles

(76) Inventor: Shantha Sarangapani, Walpole, MA (US)

Correspondence Address: RICHARD D. FUERLE, 1711 W. RIVER RD., GRAND ISLAND, NY, 14072, US

(21) Appl. No.: 11/069,705

(22) Filed: Mar. 1, 2005

Related U.S. Application Data
(63) Continuation-in-part of application No. 10/925,631, filed on Aug. 25, 2004.

(51) Int. Cl. A01N 55/02; A01N 25/00; A01N 39/00

(52) U.S. Cl. 424/405; 514/184; 424/615

(57) ABSTRACT

An antimicrobial composition is formed from about 30 to about 70 wt % of an antimicrobial formulation and about 30 to about 70 wt % of a polyurethane resin or polyurethane hybrids, copolymers, or mixtures with other polymers such as polyesters, nitrites, PVC, and synthetic rubber latexes. The antimicrobial formulation is formed from about 60 to about 95 wt % of an antimicrobial material, about 1 to about 30 wt % calcium chelator, about 0.001 to about 0.25 wt % pigment, and about 0.5 to about 3.5 wt % lubricant. The polyurethane resin may be a prepolymer that polymerizes when exposed to moisture or it may be a latex dispersion in water. An antimicrobial coating may be formed on the surface of an article by applying an antimicrobial composition to the article; if a polyurethane prepolymer is used, the composition is exposed to moisture and if an aqueous dispersion is used, the water is evaporated. A coating may also be formed by making a mixture of the antimicrobial formulation and a resin and molding, overmolding, or extruding the article from the compounded mixture.

### CROSS REFERENCE TO RELATED APPLICATION

This application is a continuation-in-part application of patent application No. 10/925,631, filed Aug. 25, 2004.

### BACKGROUND OF THE INVENTION

This invention relates to an antimicrobial formulation that can be used with silicone, silicon resins, and certain polyurethane resins to coat various surfaces, such as medical devices, including metal and metal alloy based devices. It can also be directly incorporated into medical devices and products used for non-medical applications. In particular, it relates to antimicrobial formulations that can be blended with a polyurethane resin, which may include prepolymers, copolymers of polyurethanes such as silicone-polyurethanes, or acrylic or polyester polyurethanes, solvent and water borne polyurethanes, polyurethane acrylates and polymers such as polyesters, polycarbonates, acrylates, styrene—butadiene rubbers, synthetic and natural rubber, PVC (polyvinyl chloride), water based nitrile, synthetic rubber dispersions, and emulsions. The antimicrobial formulations comprise an antimicrobial material, a calcium chelator, a pigment, and a lubricant.

Silicone and polyurethanes or blends and copolymers of polyurethanesis are soft, highly flexible and non-toxic materials extensively used for several types of medical devices, including catheters, stents, Foley catheters used for incontinence, other urological catheters, gastrostomy tubes, feeding tubes, and certain consumer products. Medical polymeric and metallic parts, like other materials, are susceptible to bacterial adherence, which leads to the formation of biofilms and the encrustation of calcium deposits when used in contact with body fluids such as urine, blood, bile, etc. The presence of bacteria on medical articles can result in infections and the spreading of diseases.

### SUMMARY OF THE INVENTION

Surfaces such as natural latex rubber or plastics or metals, can be difficult to coat with polymers, but in this invention this problem has been overcome. A coating on the surface of an article is achieved either by coating the article with a composition containing a polyurethane resin or by compounding an antimicrobial formulation with a polyurethane resin, which is molded, overmolded, or extruded into the article. The coating becomes integrated with the surface of the article and does not delaminate, swell, or separate. Due to the slow release of the antimicrobial material, such surfaces show a consistent and continuous antimicrobial activity when challenged with microorganisms.

The principal object of the present invention is to produce an antimicrobial composition that is useful for coating medical articles, or can be incorporated into medical articles, to prevent the formation of biofilms and encrusting deposits thereon.

Another object of the present invention is to provide a coatable composition that includes a polyurethane resin, prepolymers, copolymers of polyurethanes such as silicone-polyurethanes, or acrylic or polyester polyurethanes, solvent and water borne polyurethanes, polyurethane acrylates, and polymers such as polyesters, PVC, water based nitrile, synthetic rubber dispersions, and emulsions.

It is yet another object of this invention to provide coatable compositions for urinary catheters, urological devices, feed tubes, gastric buttons, and other types of devices that are made of medical polymers or other materials, such as metal and plastic stents and implants, and enhance the lubricity of the surface of a medical article by releasing a lubricious, non-toxic compound from a coating of the composition.

Yet another object of this invention is to provide antimicrobial polyurethane coatings for silica particles, surface modified silica based ceramics, textile finishes, filament wound water filters, cartridges, storage tanks, sealing caps, glove linings, gloves, and fabric coatings such as water repellent finishes.

Another object of this invention is to provide a chemical formulation for direct blending with polyurethane resins for direct extrusion or overmolding onto an article.

### DESCRIPTION OF THE PREFERRED EMBODIMENTS

The Antimicrobial Composition

The antimicrobial composition of this invention has two parts, an antimicrobial formula with four components and a polyurethane resin, which may be a prepolymer or an aqueous dispersion.

Part I (antimicrobial formulation)

(1) antimicrobial material;

(2) calcium chelator;

(3) pigment; and

(4) lubricant.

Part II (polyurethane resin)

The purpose of the antimicrobial material is to kill bacteria, yeasts, and molds. Examples of suitable antimicrobial materials include nanosize particles of metallic silver or an alloy of silver containing about 2.5 wt % copper (hereinafter referred to as “silver-copper”), salts such as silver citrate, silver acetate, silver benzoate, bismuth pyrithione, zinc pyrithione, zinc percarbonates, zinc perborates, bismuth salts, various food preservatives such as methyl, ethyl, propyl, butyl, and octyl benzoic acid esters (generally referred to as parabens), citric acid, sodium percarbonate, and urea-peroxides. The preferred antimicrobial materials are silver, partially water soluble compounds of silver, silver pyrithione, zinc pyrithione, bismuth pyrithione, parabenzoic acid esters, and mixtures thereof. Silver particles having a particle size of about 1 to about 100 nm are believed to slowly release silver ions, Ag+, which are antimicrobial. Silver and silver salts, such as silver citrate, are especially preferred, because they are very effective and safe bactericides due to their rapid release of silver ions. Propyl paraben, butyl paraben, and octyl paraben are the preferred antimicrobial materials for yeasts and molds due to their low solubility in water. About 65 to about 95 wt % of the antimicrobial formulation may be the antimicrobial material; less is ineffective. Preferably, about 40 to about 65 wt % of the antimicrobial material is used in the formulation of which about 15 to about 25 wt % is silver, silver-copper, a partially water soluble silver salt, or a mixture thereof and about 25 to about 40 wt % is parabenzoic acid esters. The antimicrobial material slowly leaches from the formulation, keeping the coated surface free of live bacteria, yeasts, and molds.

The calcium chelator prevents deposits of calcium and/or magnesium from forming, which may impede the flow of urine. Examples of suitable chelators include EDTA (diacid form), citric acid, hydroxyethylidene phosphonic acid, polyvinylphosphoric acid, polyvinylsulfonate, acrylic acid, and aminophosphonic acid. The preferred chelators are citric acid and EDTA (diacid form) because of their ability to solubilize silver and form complexes with calcium ions. About 1 to about 55 wt % (based on the weight of the antimicrobial formulation) may be chelator. More is undesirable because of its acidity and less is undesirable because the efficacy of the long term release may be reduced. Preferably, the chelator is about 20 to about 25 wt % citric acid and about 20 to about 25 wt % EDTA (diacid form).

The purpose of the pigment is for coloring, as the silver imparts a dark grayish color. The addition of the pigment imparts a bluish gray shade. Copper phthalocyanine (pigment blue) is the preferred pigment because it is believed to also have a bacteriostatic effect and is used in surgical sutures. FDA approved coloring pigments commonly used by the medical industry may also be used. About 0.001 to about 0.25 wt % (based on the weight of the antimicrobial formulation) may be pigment. More is undesirable because of the high intensity in color and the blocking effect of the large pigment molecules, and less is undesirable because the benefit of the color is lost (i.e., the color is visually not pleasing). Preferably, about 0.1 to about 0.25 wt % of the pigment is used.

The purpose of the lubricant is to make the surface lubricious, which is advantageous because it helps to prevent bacteria from adhering to the filter. Examples of suitable lubricants include polyethylene oxide, polyacrylic acid, polyvinylpyrrolidone, polyvinyl alcohol, and derivatives thereof. The preferred lubricant is polyethylene oxide because it discourages cell adhesion and can be incorporated into the antimicrobial formulation. About 4 to about 12 wt % (based on polyurethane resin solids in the formulation) is lubricant. More is undesirable because of it may make processing more difficult and less is undesirable because the surface may not be sufficiently lubricious. Preferably, about 5 to about 10 wt % lubricant is used.

For short term applications, sodium percarbonate, sodium perborate, or urea-peroxide could be used with resins in non-aqueous solvents and coated. Percarboantes and urea peroxide are activated by water and evolve hydrogen peroxide which is a potent biocide.

There are two types of polyurethane resin that may be used for coating antibacterial compositions, a prepolymer and a dispersion. The prepolymer “Hypol 2002,” sold by Dow Chemical, for example, has an equivalent weight of 633/NCO and every gram of “Hypol 2002” has 1.58 millimoles of NCO groups. This is the group that reacts with water and completes the cure. In addition, the Hypol family of prepolymers are characterized by high affinity for water (hydrophilicity) which makes the cured coating permeable to water which is important for slow release applications such as in this invention. The NCO groups come from toluene diisocyanatein the case of “Hypol 2002.” Other prepolymers contain dihydo or methylene diisocyanates, isophorone diisocyante, or tetra methyxylinyl diisocyantes. The prepolymers are normally viscous liquids. Several product types are sold by Bayer as well as Desmodur polyurethane prepolymers.

The free isocyanate groups react with moisture and form a fully polymerized polyurethane resin. A non-foaming resin, which produces a smooth surface, is made if the water is introduced by exposing the prepolymer to moisture. If the water is mixed into the prepolymer, a foam is produced. Generally, smooth surfaces are desirable, but a foam may be used for some applications, such as wound dressings, glove liners, gloves, protective clothing, filtration liners and even for water purification as a slow release medium. The prepolymers are 25 to 89 wt % solutions dissolved in a non-aqueous solvent, such as methyl ethyl ketone, acetone, tetrahydrofuran, or mixtures thereof. Examples of prepolymers include the Hypol series, sold by Dow Chemical, and the Desmodur series, sold by Bayer Company. A material called “Tecogel” polyurethane sold by Noveon, which has high hydrophilicity, may also be used as asolvent based dispersion instead of the prepolymer for coating polyurethane based devices.

The water based polyurethane dispersions are latex particles that are cationic or anionic stabilized by the charge repulsion among the particles. They are fully polymerized and do not have free isocyanate groups. They have built-in cross-linking mechanisms that cure the polymer when the water is evaporated, forming films or coatings. Examples include the Cytec products, sold by Cytec Industries, called “Cydrothane,” and also products sold by Bayer. These products are mainly used for autiomotive and buiding applications. However selected grades, such as from Cytec Industries, may be suitable for medical and glove coating applications.

The water-borne dispersions are used with about 0.1 to about 3 wt % (based on antimicrobial composition weight) of an adhesion promoter; the preferred amount of adhesion promoter is about 1 to about 2 wt %. An adhesion promoter permanently bonds the coating formulation to a surface via a cross-linking mechanism (adhesive bonding). Cross-linking also happens within the resin itself (cohesive bonding), which improves film properties and gives better heat stability and solvent and water resistances. Adhesion promoters are basically chelating agents or thin inorganic oxide formers, such that surface roughness or tethering chemistry between the coating and the surface is established.

The amount of polyurethane resin in the antimicrobial composition may be about 25 to about 80 wt %; less may not produce an adequate coating and more may produce a coating with an inadequate amount of antibacterial formulation in it. The preferred amount is about 60 to about 75 wt %. A mixture of a polyurethane resin and another resin may also be used. For example, a mixture may be made of about 60 to about 80 wt % polyurethane resin and about 49 to about 20 wt % silicone resin, such as those described in the parent of this application.

Optional components may also be included in the antimicrobial formulation. For example, it is preferable to include about 0.5 to about 4 wt % of nanosize (20 to 40 nm) high surface area titanium dioxide as a support for loading of the antimicrobial formulation and also to lighten the color. Zinc pyrithione or bismuth pyrithione are optional antimicrobial materials that may be included at very small percentages such as about 0.1 to about 0.5 wt % (based on the silicone in the formulation).

For extrusion of the antimicrobial formulation, medical grade polyurethane resins, such as the “Tecoflex” family of polyurethane materials, sold by Noveon (Cleveland, Ohio) may be used.

A preferred antimicrobial formulation is about 10 to about 16 wt % silver citrate, about 5 to about 70 wt % nanosize (i.e., less than about 100 nanometers) silver powder (about 2.5% of the weight of silver being copper nanopowder), about 5 to about 15 wt % EDTA or a vinyl phosphonic acid or hydroxy ethyl phosphonic acid, about 20 to about 40 wt % propyl paraben, and about 10 to about 22 wt % citric acid.

The antimicrobial composition of this invention may be prepared by finely blending the above-described components; blending may be performed, for example, in an industrial blender.

Coatings

The antimicrobial coating composition of this invention may be used to coat the surfaces of articles to retard the growth of microbes thereon. Examples of articles that may be coated include silica particles, surface modified silica based ceramics, textile finishes, filament wound water filters, cartridges, storage tanks, sealing caps, glove linings, gloves, and fabric coatings such as water repellent finishes. While any surface may be coated with the composition, the composition is preferably used to coat the surfaces of medical devices such as catheters, stents, Foley catheters, gastrostomy tubes, feeding tubes, silicone coated latex type surfaces silicone valves, balloons, septa, etc., that are prone to infection, silicone parts used in various medical pumps, tubings and earplugs, and as a textile finish for linings for hospital beds, window shades, and curtains. These articles may be made of various materials including plastics, metals, glass, and ceramics. Preferably, they are made of a polymeric material (a plastic), such as silicone, silicone coated plastics, and polyurethanes. The preferred material is silicone because the coating adheres better to silicone.

To coat a surface with the antimicrobial material, the surface is cleaned, if necessary, which may be done using, for example, a water-based detergent then drying thoroughly, or with an organic solvent such as ethanol, then drying and wiping the surface with hexane. The composition may be applied to the surface by any suitable technique. The following are examples of coating techniques that may be used, depending on the substrates:
Dip/immersion coating
Dip molding
Kiss coating (lick roll)
Knife coating (over air, roll or rubber sleeve)
Rotogravure coating
Spray coating
Other methods such as bar coating or rotary screen printing
   The preferred methods are dip coating and dip molding using a mandrel in the same shape as the article.

The solution or dispersion may have to be applied several times to the surface in order to achieve the desired thickness for the coating. The thickness of the coating should be about 0.5 to about 2 mils as thinner coatings may be less effective and thicker coatings may not be necessary. A preferred thickness is about 1 to about 2 mils. After each layer of coating is applied, the surface is dried. This may be accomplished, for example, by air drying or by warming the surface in an oven. The composition is preferably dried at room temperature followed by drying at about 50 to about 60° C. for about 3 to about 4 hours. Articles with balloons made of silicone, such as Foley silicone catheters, may be easily coated with the composition of this invention and were found to pass both the ASTM and the European standard test for balloon expansion in Foley catheters and the burst strength tests.

To form an article by dip molding, a mandrel in the shape of the article is heated, dipped into a tank holding an antimicrobial composition, and removed from the tank. The viscosity of the solution depends on its solids content, which can be increased by adding more solids or decreased by adding more solvent until the desired viscosity is attained. After dipping, the thin coating of the composition that remains on the surface of the mandrel is allowed to dry and/or cure, then is stripped off as a finished product. Multiple dipping steps may be used to increase the thickness of the coating and curing time, temperature, and speed of immersion may be adjusted to control the properties of the resulting article. Gloves, balloons, and other articles may be made by this process.

Incorporation of the Formulation

The antimicrobial formulation of this invention may also be incorporated into an article, so that it will gradually leach to the surface of the article and form a coating on the surface that retards the growth of microbes thereon. This is made by compounding a solid resin of polyurethane, polyesters or medical grade polymeric materials, liquid or solid silicone with the antimicrobial composition, followed by extrusion. Materials in which the formulation may be incorporated include silicone resins, liquid silicone, polyurethanes, polyvinyl chloride (PVC), and silicone-polyurethane blends. The preferred material is liquid silicone because of its ability to form conformal molded shapes and also conformal overmolded parts. This also avoids the need to use a solvent.

To incorporate the formulation into a material, the formulation is mixed with the material to produce a homogeneous mixture. The mixture may contain about 5 to about 20 wt % of the formulation; less formulation may not be sufficiently effective in retarding the growth of microbes and more formulation may adversely affect the properties of the material. Preferably, the formulation is about 5 to about 12 wt % of the mixture.

The mixture is then formed into a desired shape and is hardened. The article may be shaped by molding, overmolding, extrusion, or another process. Depending upon the resin used, hardening may occur as a result of exposure of the material to air, heat, moisture, or as the result of a chemical reaction that began when the resin was prepared.

The methods result in the formation of an excellent product that facilitates the slow release of antimicrobials to the surface. The silicone resin encapsulates the antimicrobial materials and releases them at a controlled rate. On exposure to aqueous fluids, such as various body fluids, the water soluble components of the antimicrobial formulation migrate to the surface, where an equilibrium between the silver, citric acid, and EDTA is established. This is important because silver ions are rendered insoluble due to the formation of silver chloride or phosphates in the presence of body fluids. The presence of EDTA, which complexes silver ions, forming soluble complexed species of silver, allows a continuous migration of these soluble species to the surface despite the presence of chloride ions. The presence of the other components of the formulation, such as parabens (para benzoic acid esters) and copper phthalocyanine, help to keep the surface of the coated article antimicrobial. The lubricant imparts a slippery feel when wetted with water; this property allows the insertion of the catheter without causing trauma to the patient. More importantly, the lubricant elutes continuously from the coating, keeping the surface hydrophilic and lubricious, thereby discouraging the adherence of bacteria.

Incorporation of the antimicrobial formulation into an article is preferred to coating a surface with the composition as it is a less time-consuming procedure.

The following examples further illustrate this invention.

### EXAMPLE 1

### This is Example of Coating Silicone on Silicone Material

The following chemicals were blended:

(1) 3.0 g (16.12 wt %) silver citrate (Sigma-Aldrich Chemical, USA)

(2) 1.5 g (8.0 wt %) silver-copper alloy nanopowder (Nanopowder Ind,, Israel)

(3) 3.0 g (16.12 wt %) citric acid (Sigma-Aldrich)

(4) 8.9 g (43.0 wt %) butyl paraben (Spectrum Chemicals, USA)

(5) 3.0 g (16.12 wt %) ethylene diamine tertaacetic acid, diacid form (Sigma-Aldrich)

(6) 0.1 g (0.05 wt %) copper phthalocyanine (Spectrum Chemical) Ten grams of this blend was added to another 0.25 gm of copper phthalocyanine and 150 mL of dry n-hexane. To that mixture was added 75 gm of “RTV 118” (McMaster Co, NJ, USA). To this was slowly added 5 gms dry pulverized polyethylene oxide (MW 4,000,000). Using a homogenizer, the contents were mixed well and transferred to a dipping tank, forming a solution containing about 1 to 15 wt % of the antimicrobial composition.

The silicone surfaces of 3 silicone Foley catheters were cleaned by wiping with n-hexane. The catheters were dip-coated once by immersing them for a minute or two in the solution at room temperature. After a few seconds, the catheters were dip coated a second time. The coated catheters were allowed to air dry for a few minutes (1 to 3 minutes) and were then dried in a convection oven at 75 to 85° C. for 30 minutes. The catheters were removed and kept in a dark area. (The coated articles are preferably stored in light proof packages because the coating tends to darken on direct exposure to light.) When challenged with organisms such as clinical strains of species of E. coli, Enterococcus, and Candida, the coated catheters resisted the formation of biofilms significantly better than the uncoated catheters.

### EXAMPLE 2

Composition A

The following formulation was prepared without titanium dioxide:

16.1 wt % silver citrate

8.0 wt % silver-copper

16.0 wt % citric acid

43 wt % butyl paraben

16 wt % EDTA, diacid form

1 to 3 wt % copper phthalocyanine

The ingredients were weighed and ground to a fine powder in an industrial blender. Prior to coating, 5 wt % polyethylene oxide (based on the weight of the RTV silicone resin to be added), was added to the powder and ground well. The composition was kept dry, in closed containers or in a low temperature oven.

Composition B

A second formulation was prepared with titanium dioxide.

10.5 wt % silver citrate

5.3 wt % silver-copper

21.0 wt % citric acid

42 wt % butyl paraben

10.5 wt % EDTA, diacid form

4.2% copper phthalocyanine

6.3 wt % titanium dioxide

Prior to coating, 5 wt % polyethylene oxide (based on the RTV silicone resin weight to be added), was added separately. Alternatively, the polyethylene oxide can be blended with the compositions under very dry conditions, preferably with the powder, prior to preparing the coating formula.

### EXAMPLE 3

Using a 200 mesh screen, 4 gms of the powder compositions 2A and 2B were sieved and dried in an oven at about 50° C. for 30 minutes. Polyethylene oxide powder was also sieved using a 325 mesh screen and dried at about 50° C. for 30 minutes to an hour. The polyethylene oxide and the powder composition were mixed together under dry conditions. Then 6 gm of “GE 118” RTV silicone resin was diluted with 60 gm of hexane that had been dried using molecular sieves. The mixture of the polyethylene oxide and the powder composition were slowly mixed and the new mixture was sonicated at level 3 for 8 minutes. Then 26 gm of “GE 118” RTV silicone resin was stirred in at room temperature.

Articles were dipped into the solution 1 to 3 times, each time drying the coating for at least 15 minutes at room temperature. The coatings were air-dried under ambient humid conditions overnight followed by further drying at 60° C. for 1 to 2 hrs.

In this example, duplicate samples(referred to as A and B) of catheters (coated composition form this invention and duplicates one uncoated control and duplicates of one commercial sample (Bardex antimicrobial hydrogel catheter) were cut into 2-cm length samples and placed in separate sterile tubes. 50 μl of a vancomycin-resistant enterococcus fecalis (VRE) cell solution (clinical isolate from UTI), 0.5 McFarland, was inoculated into a 12.5 ml “artificial urine” solution prepared by the procedure described in “An Improved Model for Bacterial Encrustation Studies,” by S. Sarangapani, D. Gage, and K. Cavedon, J. Biomed. Mater. Sci., 29, 1185 (1995), herein incorporated by reference. The inoculum solution was plated to confirm that the concentration of VRE cells was 1×10⁵ on Day 0. 1 mL of the synthetic urine solution and 1 mL of the inoculum culture were added to each tube containing the catheter samples, and the tubes were incubated at 36° C., rotating at 20 rpm (Day 0).

Upon completion of various incubation times (days 1, 2, 4, and 7), the following assays were performed separately on the duplicate samples for each day of incubation:

1 mL of the synthetic urine solution and 1 mL of the inoculum culture were added to each tube containing the catheter samples, and the tubes were incubated at 36° C., rotating at 20 rpm

On Day 0, there was planctonic growth on the contacting solution (CS). The attached viable cells (biofilm) on the catheter pieces (S) were counted.

On Day 4, a set of all the catheter samples was transferred to new test tubes and a fresh solution of artificial urine was added.

On Day 7, these samples were assayed for planctonic growth of the contacting solution (CS) and for attached viable cells (biofilm) (S). They are designated as DAY 7+.

The protocols for these assays are listed in Appendix A. The results of this experiment are summarized in Table 1.

TABLE 1
VRE experiment (CFU/ml)

| | | ENTEROCOCCUS TEST | | | | | | | | | |
|---|---|---|---|---|---|---|---|---|---|---|---|
| CATHETER | | DAY 1 | | DAY 2 | | DAY 4 | | DAY 7 | | DAY 7+ | |
| TYPE | SAMPLE | S | CS | S | CS | S | CS | S | CS | S | CS |
| Catheter from | A | <10³ | <10³ | <10³ | <10³ | <10³ | <10³ | <10³ | <10³ | <10³ | <10³ |
| example 3 | | | | | | | | | | | |
| | B | <10³ | <10³ | <10³ | <10³ | <10³ | <10³ | <10³ | <10³ | <10³ | <10³ |
| | Ave | <10³ | <10³ | <10³ | <10³ | <10³ | <10³ | <10³ | <10³ | <10³ | <10³ |
| Bardex silver | A | 7 × 10⁵ | 8 × 10⁶ | 1.6 × 10⁶ | 3 × 10⁷ | 10⁵ | 2 × 10⁷ | 10⁴ | 2 × 10⁷ | 6 × 10⁵ | 4 × 10⁷ |
| hydrogel | | | | | | | | | | | |
| | B | 8 × 10⁵ | 5 × 10⁶ | 5 × 10⁵ | 2 × 10⁷ | 6 × 10⁵ | 4 × 10⁷ | 3 × 10⁴ | 10⁷ | 4 × 10⁴ | 10⁷ |
| | Ave | 7.5 × 10⁵ | 6.5 × 10⁶ | 1.05 × 10⁶ | 2.5 × 10⁷ | 3.5 × 10⁵ | 3 × 10⁷ | 2 × 10⁴ | 1.5 × 10⁷ | 3.3 × 10⁵ | 2.5 × 10⁷ |
| Uncoated | A | 5 × 10⁵ | 8 × 10⁸ | 2 × 10⁴ | 3 × 10⁸ | 9 × 10⁴ | 2 × 10⁷ | 2 × 10⁴ | 2 × 10⁷ | 10⁴ | 2 × 10⁷ |
| control | | | | | | | | | | | |
| | B | 6 × 10⁵ | 7 × 10⁸ | 3 × 10⁴ | 3 × 10⁸ | 5 × 10⁴ | 2 × 10⁷ | 2 × 10⁵ | 3 × 10⁶ | 4 × 10⁴ | 3 × 10⁷ |
| | Ave. | 5.5 × 10⁵ | 7.5 × 10⁸ | 2.5 × 10⁴ | 3 × 10⁸ | 7 × 10⁴ | 2 × 10⁷ | 1.1 × 10⁵ | 1.15 × 10⁷ | 2.5 × 10⁴ | 2.5 × 10⁷ |

Note
Ave = average of the duplicate sample.

Tubes coated according to this invention showed silver leaching of 1.5 to 2 ppm in minimum essential medium extractions when extracted under USP (United States Pharmacopia) recommended procedure conditions. However, when extracted with PBS (phosphate buffered saline), the silver in the USP extracts was less than 0.2 ppm.

Appendix A—Protocol of assays

Planctonic growth assay of contacting solution (CS):

1. Vortex sample in its contacting solution for 10 seconds, then remove sample to tube with 2 mL of sterile PBS.

2. Plate 1 ml of at least two dilutions of the contacting solution onto tryptic soy agar +5% defibrinated sheep blood (TSA+5% DSB) agar plates.

3. Incubate plates at 37° C. for 24 to 48 hours. Determine CFU (colony forming units) by viable plate count method.

Biofilm Assay (S):

1. Remove planctonic cells from biofilm: Vortex sample in sterile PBS for 10 seconds, then transfer it to a second 2mL PBS tube and vortex again.

2. Disaggregate bacteria by vortexing 10 seconds and sonicating at 35 KHz for 5 minutes on ice.

3. Plate 1 ml of at least two dilutions onto TSB+5% DSB agar plates.

4. Incubate plates at 37° C. for 24 to 48 hours. Determine CFU by viable plate count method.

### EXAMPLE 4

Duplicate samples of two silicone catheters, one coated and one uncoated control, were cut into 2-cm length samples and each was placed in a separate sterile tube. Inoculum cultures of 1×10⁵ E. coli cells/mL (clinical isolate from UTI) in synthetic urine were prepared. 1 mL of synthetic urine solution and 1 mL inoculum culture were added to each tube containing the catheter samples, and the tubes were incubated at 36° C., rotating at 20 rpm. (Day 0)

Upon completion of incubation time (Days 1, 4), the following assays were performed on separate duplicate samples for each day of incubation:

(1) planktonic growth of the contacting solution (CS); and

(2) counting of attached viable cells (biofilm) on the catheter pieces (S).

The protocols for these assays are listed in Appendix A. The dilutions tested were: 1:10, 10², 10³, 10⁴.

The results of the preliminary experiment are summarized in Table 2.

TABLE 2
Preliminary experiment
Preliminary test E. coli (CFU/ml)

| | | DAY 1 | | DAY 4 | |
|---|---|---|---|---|---|
| CATHETER TYPE | TIME | S | CS | S | CS |
| Uncoated Control (D) | A | 10⁵ | 2 × 10⁷ | 10⁵ | 6 × 10⁸ |
| | B | 10⁵ | 10⁷ | 4 × 10⁵ | 2 × 10⁸ |
| | Ave | 10⁵ | 1.5 × 10⁷ | 2 × 10⁵ | 4 × 10⁸ |
| Coated from this | A | <10³ | <10³ | 10³ | 10³ |
| invention | | | | | |
| | B | <10³ | <10³ | <10³ | 10³ |
| | Ave | <10³ | <10³ | 10³ | 10³ |

Note:
Ave is the average of the duplicate samples.

On Day 1 of this experiment, the S and CS solutions were plated in parallel onto MacConkey plates. The results were comparable and therefore it was decided to continue with the more selective MacConkey plates for the evaluation of the different catheters.

Evaluation of Different Catheters with E. Coli

Duplicate samples of 5 different coated catheters, and one uncoated control catheter, were cut into 2-cm length samples and each was placed in a separate sterile tube. An inoculum culture of 1×10⁵ E. coli cells/mL (clinical isolate from UTI) in synthetic urine was prepared. 1 mL of the synthetic urine solution and 1 mL of the inoculum culture were added to each tube containing the catheter samples and the tubes were incubated at 36° C., rotating at 20 rpm (Day 0).

Upon completion of the incubation times (Days 1, 2, 4, and 7), the following assays were performed on separate duplicate samples for each day of incubation:
(a) planktonic growth of the contacting solution (CS); and
(b) counting of attached viable cells (biofilm) on the catheter pieces (S).

On Day 4, only the contacting solution was assayed. The catheter samples were not sonicated, but rather were transferred to new test tubes with a fresh challenge of 1×10⁵ E. coli cells. After an additional 3 days (which corresponded to Day 7 of the overall experiment), these samples were assayed for planctonic growth of the contacting solution (CS) and for attached viable cells (biofilm) (S). They are designated as DAY 7+. The protocols for these assays are listed in Appendix B, with the modification that the different dilutions were plated onto MacConkey agar. The results of this experiment are summarized in Table 3.

TABLE 3
E. Coli experiment (CFU/ml)

| CATHETER | | DAY 1 | | DAY 2 | | DAY 4 | | DAY 7 | | DAY 7+ | |
|---|---|---|---|---|---|---|---|---|---|---|---|
| TYPE | Sample | S | CS | S | CS | S | CS | S | CS | S | CS |
| Bardex | A | 7 × 10⁴ | 2 × 10⁷ | 2 × 10⁵ | 6 × 10⁷ | N.D | 10⁸ | 3 × 10⁶ | 10⁹ | 1.6 × 10⁶ | 7 × 10⁸ |
| silver | | | | | | | | | | | |
| hydrogel | | | | | | | | | | | |
| | B | 6 × 10⁴ | 10⁷ | 2 × 10⁵ | 10⁸ | N.D | 2 × 10⁸ | 3 × 10⁶ | 4 × 10⁸ | 1.4 × 10⁶ | 10⁸ |
| | Ave | 6.5 × 10⁴ | 1.5 × 10⁷ | 2 × 10⁵ | 0.8 × 10⁸ | N.D | 1.5 × 10⁸ | 3 × 10⁶ | 0.7 × 10⁹ | 1.5 × 10⁶ | 4 × 10⁸ |
| Catheter | A | <10³ | <10³ | <10³ | <10³ | N.D | <10³ | <10³ | <10³ | <10³ | <10³ |
| coating | | | | | | | | | | | |
| from this | | | | | | | | | | | |
| invention | | | | | | | | | | | |
| | B | <10³ | <10³ | <10³ | <10³ | N.D | <10³ | <10³ | <10³ | <10³ | <10³ |
| | Ave | <10³ | <10³ | <10³ | <10³ | N.D | <10³ | <10³ | <10³ | <10³ | <10³ |
| Uncoated | A | 10⁵ | 3 × 10⁸ | 2 × 10⁵ | 4 × 10⁸ | N.D | 3 × 10⁸ | 10⁶ | 3 × 10⁸ | 10⁶ | 8 × 10⁸ |
| control | | | | | | | | | | | |
| | B | 10⁵ | 4 × 10⁸ | 8 × 10⁴ | 7 × 10⁷ | N.D | 4 × 10⁸ | 4 × 10⁵ | 10⁸ | 1.5 × 10 6 | 9 × 10⁸ |
| | Ave | 10⁵ | 3.5 × 10⁸ | 1.4 × 10⁵ | 2.35 × 10⁸ | N.D | 3.5 × 10⁸ | 0.7 × 10⁶ | 2 × 10⁸ | 1.25 × 10⁶ | 8.5 × 10⁸ |

Note:
Ave = average of the duplicate samples.
(N.D) = Not determined

### EXAMPLE 5

Four tubes, about 2 inches long, made of untreated silicone (control), another four of an experimental catheter product, another four of “Bardex” (a silver-hydrogel coated catheter made by Bard Urological Products, Atlanta, USA), and another four catheters coated as described in Example 1 were used in this experiment. The tubes were flash sterilized in 70 wt % ethanol and were let air dry in a sterile environment. Each sample of the catheter pieces was added to a sterile tube. To each tube was add 0.9 mL synthetic urine and 0.1 mL of innoculum containing ˜10⁶ cfu/mL of the organism being tested. The tubes were incubated overnight at 37° C., then decanted and the solutions were replaced for Days 2 to 4. The following tests were performed on the Day 1 samples.

For each sample to be tested, 4 sterile tubes were filled with PBS, the first three not accurately measured, and the fourth one accurately measured to 5 mL. The sample was vortexed in the innoculum solution for 5 seconds. Each sample was transferred to a PBS containing tube. The plate contacting the innoculum was swabed. The sample was vortexed with PBS containing the samples for 20 seconds and was transfer to another sterile tube containing PBS. The process was repeated 2 more times. After the last vortexing, the samples were removed with sterile forceps and the cell was scraped with a cell scraper all around the tube for about ˜8 scrapes. The sample and the cell scraper tip were added to the sterile tube containing 5 mL PBS. The contents were vortexed for a short time and kept in an ultrasonic bath for 10 minutes to release the biofilm into solution. Then 0.1 mL of each of the resulting solutions was plated onto agar plates, followed by incubation at 37C. The following graph gives the results:

[image]

### EXAMPLE 6

It was surprisingly found that hydrophilic polyurethane prepolymers, such as “Hypol 2002,” sold by Dow Chemical, could be blended with the antimicrobial compositions from this invention as a solvent-based paint-like formulation, such as from Examples 1 and 2, and coated on latex rubber substrates directly. The following powder composition was used:

Silver Citrate: (Sigma-Aldrich): 1.0 gm ( 27.7%

Silver powder 1-2 microns (Advanced Materials, Conn, USA).: 0.4875 g; 13.5%

Copper nanopowder (Advanced Materials): 0.0125 gm;0.3%

EDTA (diacid form) 1.0 gm; 27.7%

Propyl paraben: 1.0 gm; 27.7%

Coloring pigment: 0.1 gm.2.7%

The above composition was ground well and homogenized under dry conditions. The composition (1.2 gm) was dispersed into 10 gm of a dispersing solvent, methyl ethyl ketone (MEK, Sigma-Aldrich), stirred for 15 minutes and sonicated for 5 minutes. Then 2.5 gm of “Hypol 2002” was dissolved in 10 gm of MEK and the dispersion was added, followed by the addition of 1 gm of polyethylene oxide. The mixture was stirred for 15 minutes at room temperature. An additional 7.5 gm of “Hypol 2002” was dissolved in 5 gm of MEK and was added to the mixture and stirred well.

This formula had a thin paint-like consistency and was coatable. Latex tubes and pre-washed and thoroughly dried latex catheters (in a 1:1:1 isopropyl alcohol/water/ toluene mixture by weight) were dip-coated directly into this mixture. The coatings were cured at room temperature using a trough of water for humidification under the drying catheters. Curing was complete in about 2-3 days at ambient room temperature or at 30° C. The typical coat weights were approximately 5 to 20% of the substrate weight depending on the number of dips.

The resulting product showed excellent lubricity, antimicrobial activity, adhesion to latex materials, and excellent stability against delaminating in biological media. Such coatings are suitable for gloves as well.

Water-borne polyurethanes, such as those sold by Cytec Industries (e.g., “Cydrothane HB 4033” or “Noveon Permax 120”) may also be blended with the powder formulations from this invention and applied on rubber or polymeric substrates primed with silane coupling agents such as amino alkyl silanes. In fact, water-borne polyurethanes containing the powder formulation from this invention without the polyethylene oxide (PEO) may also be used to coat latex substrates after priming the substrate with silanes or adhesion promoters such as the DuPont “Tyzor” or zirconium compounds.

A wider application to multilayered configured materials with antimicrobial and protective properties are foreseen from this invention.

I claim:

1. An antimicrobial composition comprising
(I) about 30 to about 70 wt % of an antimicrobial formulation that comprises
(A) about 40 to about 65 wt % of an antimicrobial material;
(B) about 1 to about 55 wt % calcium chelator;
(C) about 0.001 to about 0.25 wt % pigment; and
(D) about 0.5 to about 12 wt % lubricant; and
(II) about 30 to about 70 wt % of a resin selected from the group consisting of polymers from the family of polyurethanes, polycarbonates, acrylates, nitrites, silicones, polyvinyl chloride, synthetic and natural rubber, styrene- butadiene rubber, and their copolymers and blends.

2. An antimicrobial composition according to claim 1 wherein said antimicrobial material is selected from the group consisting of silver, silver-copper mixtures, partially water soluble compounds of silver, silver pyrithione, zinc pyrithione, bismuth pyrithione, parabenzoic acid esters, percarbonate, perborate, urea-peroxide compounds, and mixtures thereof.

3. An antimicrobial composition according to claim 1 wherein said calcium chelator is citric acid, ethylene diamine tetraacetic acid (diacid form), or a mixture thereof.

4. An antimicrobial composition according to claim 1 wherein said pigment is copper phthalocyanine.

5. An antimicrobial composition according to claim 1 wherein said lubricant is polyethylene oxide.

6. An antimicrobial composition according to claim 1 that includes about 0.5 to about 4 wt % titanium dioxide.

7. An antimicrobial composition according to claim 1 wherein said polyurethane resin is an aqueous dispersion.

8. An antimicrobial composition according to claim 7 which includes about 0.5 to about 3 wt % of an adhesion promoter.

9. An antimicrobial composition according to claim 1 wherein said polyurethane resin is a prepolymer that polymerizes in the presence of moisture.

10. A method of forming an antimicrobial coating on the surface of an article comprising applying an antimicrobial composition according to claim 7 to said surface and permitting said solvent to evaporate.

11. A coated article made according to the method of claim 10.

12. A method of forming an antimicrobial coating on the surface of an article comprising applying an antimicrobial composition according to claim 9 to said surface and exposing said surface to moisture.

13. A method according to claim 12 wherein said article is made of a polymer, copolymer or blends or composites, natural latex rubber or synthetic rubber or metal and metal alloys.

14. A coated article made according to the method of claim 11.

15. A method according to claim 11 wherein said surface is a mandrel and, after said coating is formed, it is removed from said mandrel.

16. A method of forming an antimicrobial coating on the surface of an article comprising molding, overmolding, or extruding said article from an antimicrobial composition according to claim 1.

17. A method according to claim 16 wherein said polymeric resin is a solid or a dispersion in a solvent.

18. A coated article-made according to the method of claim 17.

19. An antimicrobial composition comprising
(I) about 5 to about 25 wt % of an antimicrobial formulation that comprises
(A) about 15 to about 25 wt % of silver, silver-copper, a partially water soluble silver salt, or mixtures thereof and about 25 to about 45 wt % of parabenzoic acid esters;
(B) about 20 to about 25 wt % citric acid and about 20 to about 25 wt % ethylene diamine tetraacetic acid (diacid form);
(C) about 0.1 to about 0.25 wt % copper phthalocyanine;
(D) about 4 to about 10 wt % lubricant; and
(E) about 0 to about 4 wt % titanium dioxide; and
(II) about 25 to about 95 wt % of a polyurethane prepolymer that polymerizes in the presence of moisture or a polyurethane latex dispersion in water.

20. An antimicrobial composition comprising
(I) about 5 to about 25 wt % of an antimicrobial formulation that comprises
(A) about 15 to about 25 wt % of silver, silver-copper mixture, a partially water soluble silver salt, or mixtures thereof and about 25 to about 45 wt % of parabenzoic acid esters;
(B) about 20 to about 25 wt % citric acid and about 20 to about 25 wt % ethylene diamine tetraacetic acid (diacid form);
(C) about 0.1 to about 0.25 wt % copper phthalocyanine;
(D) about 4 to about 5 wt % lubricant; and
(E) about 0 to about 4 wt % titanium dioxide;
(II) about 75 to about 95 wt % of a polyurethane latex dispersion in water; and
(III) about 0.5 to about 3 wt % of an adhesion promoter.
